(19) United States
(12) Patent Application Publication
(10) Pub. No.: US 2007/0119876 A1
(43) Pub. Date: May 31, 2007

(54) Easy grout

(76) Inventors: Michael Roberts, Nottingham (GB); Jeffery Roberts, (US)

Correspondence Address: ADVANTIA LAW GROUP, 9035 SOUTH 1300 EAST, SUITE 200, SANDY, UT, 84094, US

(21) Appl. No.: 11/290,996

(22) Filed: Nov. 29, 2005

(51) Int. Cl. B67D 5/42

(52) U.S. Cl. 222/391

(57) ABSTRACT

A grout applicator including a chamber, a lid, a hose or hose assembly and a stop. The chamber includes a top, bottom, side wall, mixing aperture, and an extrusion aperture. The mixing aperture is through the top. The extrusion aperture is through the side wall and closer to the bottom than the top. The lid may include a cover, a shaft, a plunger, and/or an actuator. The hose is flexible and transparent. The stop is coupleable to the extrusion aperture and configured to form a fluid tight seal when coupled thereto, thereby preventing escape of fluid from the chamber.

### BACKGROUND OF THE INVENTION

1. Field of the Invention

The present invention relates to applicators, specifically to grout applicators for tiling.

2. Description of the Related Art

U.S. Pat. No. 6,484,782 discloses a grout slurry pumping system, and a grout slurry control box and associated tools. Methods of using the pumping system and control box are also described. The pumping system and control box may be used separately or together. The pumping system maintains a grout slurry of desired consistency and can provide it through a hose to remote locations. The control box operates to apply grout to a work surface in desired quantities and in desired amounts according to a control valve.

U.S. Pat. No. 5,878,921 discloses a grout delivery apparatus and method for delivering grout through a flexible conduit from a bulk supply of grout to a hand tool. The bulk supply of grout is held in a hopper which feeds the grout under gravity to a pump. The pump is driven by an electric motor which receives its electrical energy through a controller. The controller is adjustably preset to control the electric motor as a function of the individual settings on a multifunction switch operable by the worker. The switch can either be mounted on the hand tool and directly wired to the controller or incorporated into a remote transmitter which transmits the particular switch position to a receiver on the controller.

U.S. Patent Application No. 2004/0069817 discloses a hand-operated, portable sprayer to selectively produce a foamy effluent spray, rather than only the purely liquid spray provided by conventional sprayers. The sprayer includes segregated air and liquid delivery systems that separately supply air and liquid from the pressurized tank reservoir to a mixing chamber. Foaming may be facilitated by incorporating a mixing medium in or downstream from the mixing chamber. A flow controller is provided to control the flow of output from the sprayer. The flow controller and the mixing chamber may be incorporated into a single component. A valve may be included in the air delivery line to allow the users to attenuate the air flow rate to the mixing chamber, thereby permitting the user to select the consistency of the effluent foam according to the particular application.

What is needed is an applicator that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available grout applicators. Accordingly, the present invention has been developed to provide an improved grout applicator.

In one embodiment there is a grout applicator. The grout applicator may include a chamber, a lid, a hose or hose assembly and/or a stop. The chamber may include a top, bottom, side wall, mixing aperture, and/or an extrusion aperture. The mixing aperture may be through the top. The extrusion aperture may be through the side wall and/or closer to the bottom than the top.

The lid may be coupleable to the top of the chamber such that the mixing aperture may thereby be sealed. The lid may include a cover, a shaft, a plunger, and/or an actuator. The cover may be configured to cover the mixing aperture. The shaft may be through the cover. The plunger may be coupled to the shaft such that the plunger moves vertically in association with vertical movement of the shaft. The plunger may be shaped to conform to a horizontal cross-sectional shape of the side wall of the chamber. The actuator may be coupled to the shaft and/or the cover and/or configured to cause the shaft to move vertically when the actuator is actuated.

The hose and/or hose assembly may be flexible and/or transparent. The hose and/or hose assembly may be coupleable to the extrusion aperture and/or configured to fluidly couple to the chamber when coupled thereto and/or may include a nozzle coupled and/or coupleable to the hose and configured to direct fluid flow therefrom. There may also be a stop that may be coupleable to the extrusion aperture and/or configured to form a fluid tight seal when coupled thereto, thereby preventing escape of fluid from the chamber.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a grout applicator in a mixing mode according to one embodiment of the invention;

FIG. 2 illustrates a grout applicator in an application mode according to one embodiment of the invention; and

FIG. 3 illustrates an exploded view of a grout applicator according to one embodiment of the invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

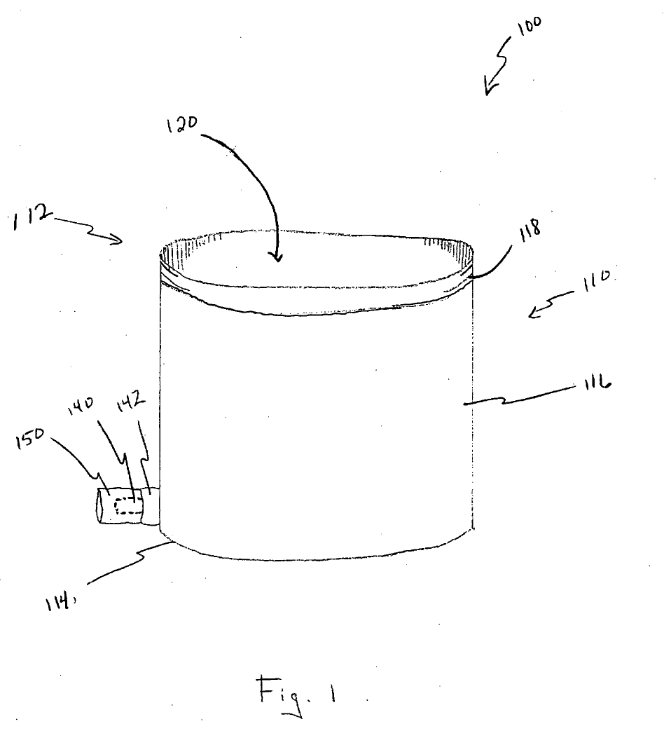

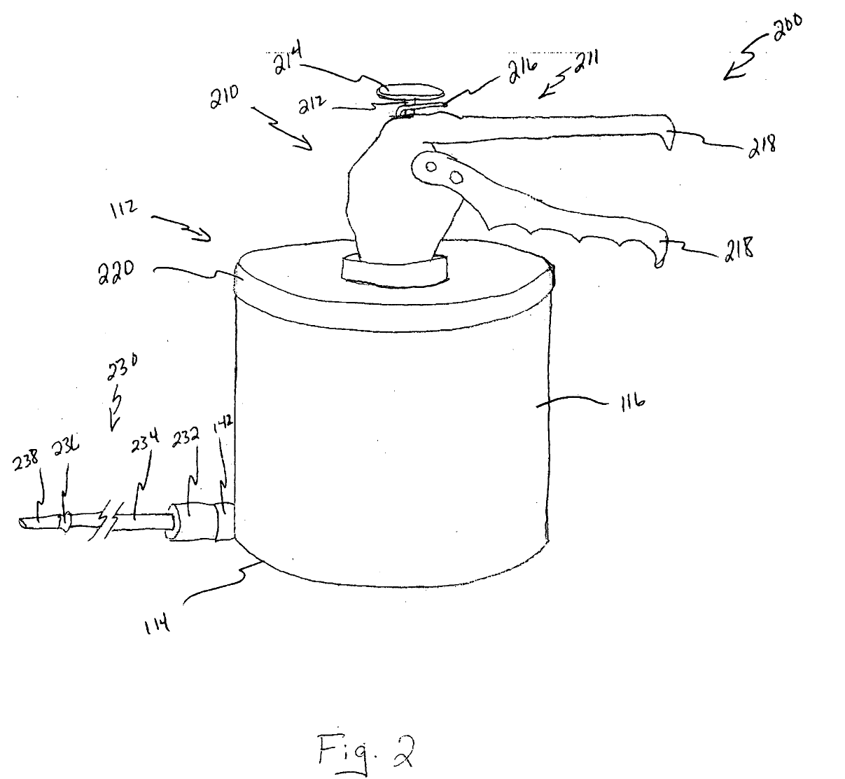

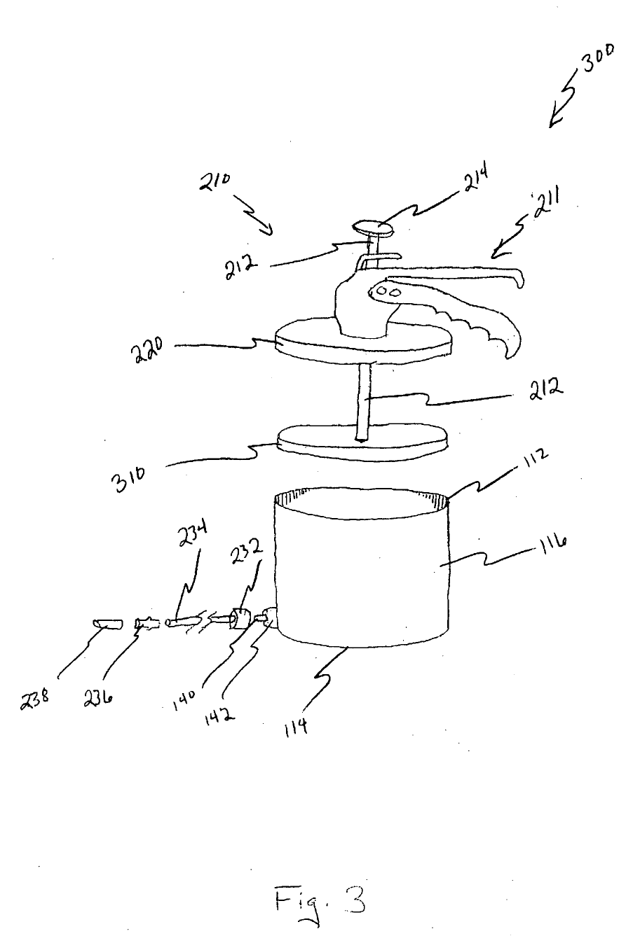

FIGS. 1-3 illustrate a grout applicator according to one embodiment of the invention. There is shown a grout applicator in a mixing mode 100, a grout applicator in an application mode 200, and an exploded view of a grout applicator 300. The grout applicator illustrated includes a chamber, pot, or container 110 of a material substantially impermeable to fluids, such as but not limited to plastic. The pot 110 includes a top 112, a bottom 114, and a side wall 116. The pot 110 includes a mixing aperture 120 through the top 112. The pot 110 may be a cylindrical member having a solid and substantially planar bottom 114. There is also an extrusion aperture 140 and 142 through the side wall and closer to the bottom 114 than the top 112. The extrusion aperture 140 and 142 may include an aperture housing 140 and an extension tube 142. The extrusion aperture 140 and 142 may extend from the chamber 110 substantially perpendicular from the side wall 116 and/or substantially planar to the bottom 114 and/or substantially perpendicular to a motion of the plunger 310 when in operation.

There is also shown a lid 210 coupleable to the top 112 of the chamber 110 such that the mixing aperture may thereby be sealed. There is illustrated a set of threads 118 that may couple to associated threads (not shown) internal the lid 210. The illustrated lid 210 includes a cover 220 configured to cover the mixing aperture 120, a shaft 212 through the cover 220, a plunger 310 coupled to the shaft 212 such that the plunger 310 moves vertically in association with vertical movement of the shaft 212, the plunger 310 shaped to conform to a horizontal cross-sectional shape of the side wall 116 of the chamber 110, and an actuator 211 coupled to the shaft 212 and the cover 220 and configured to cause the shaft 212 to move vertically when the actuator 211 is actuated.

The cover 220 may be a substantially planar solid member configured to couple to the top 112 of the chamber 110. The shaft 212 is preferably a metal rod. The plunger 310 is preferably an elastic material such as but not limited to soft plastic or rubber. The actuator 211 is preferably a ratcheting-type actuator whereby actuation of the actuator 211 such as by applying a force to handles 218 the shaft 212 may be advanced in a direction from a first position to a second position and prevented from moving back to the first position. There may be a stop plate 214 coupled to the shaft 212 to prevent the shaft from being positioned too far through the lid 210.

There is shown a hose assembly 230 including a hose 234 that may be a substantially transparent and/or flexible hose coupleable to the extrusion aperture 140 and/or 142 by means of the aperture coupler 232 and configured to fluidly couple to the chamber 10 when coupled thereto. There is also shown a nozzle 238 coupled to the hose 234 through a coupler 236 that is inserted into each of the hose 234 and the nozzle 238. The nozzle 238 is configured to direct fluid flow from the hose 234 to a surface. There is also shown a stop 150 coupleable to the extrusion aperture 140 and/or 142 and configured to form a fluid tight seal when coupled thereto, thereby preventing escape of fluid from the chamber 110.

In operation, a user may remove the lid 210 from the chamber 110. The user may also attach the stop 150 to the extrusion aperture 140 and/or 142. Preferably the extrusion aperture 140 and 142 is a click fit male connector. Preferably the stop 150 is a click fit stop end configured to couple to the extrusion aperture, thereby enabling a user to quickly and easily attach/detach the stop to/from the extrusion aperture 140 and 142. The user may insert grout materials such as but not limited to powder and water and may mix such materials in the chamber 110 without concern of material escaping the chamber through the extrusion aperture 140 and 142.

The user may remove the stop 150 and attach the hose assembly 230 to the extrusion aperture 140 and 142. Preferably the aperture coupler 232 is a click fit coupler, thereby permitting a user to quickly and easily couple the hose assembly 230 to the extrusion aperture 140 and 142. The user may also couple the lid 210 to the chamber 110. In one example, the user may screw the lid 210 to the chamber 110. The user may actuate the actuator 211 to force the shaft 212 downward towards the bottom 114 of the chamber 110, thereby causing the plunger 310 to move downward towards the bottom 114 of the chamber 110. Such may apply pressure to a mixture contained within the chamber 110. Such pressure may be used by the user to control a flow of the mixture through the extrusion aperture 140 and 142 and the hose assembly 230. Advantageously the hose may be flexible and/or substantially transparent, thereby enabling a user to direct the nozzle 238 to a desired disposition and/or orientation and/or enabling a user to be aware of the presence or lack thereof of a mixture within the hose 234.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

For example, it is envisioned that an embodiment of the invention may be useful for all types of tiling.

Finally, it is envisioned that the components of the device may be constructed of a variety of materials. While certain material may be preferred over others, each of the listed parts of an embodiment may be constructed of plastic, metal, ceramic, wood, fiber, composite, etc.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. What is claimed is:

1. A grout applicator, comprising:
a chamber of a material substantially impermeable to fluids, including:
a top, a bottom, and a side wall;
a mixing aperture through the top; and
an extrusion aperture through the side wall and closer to the bottom than the top; and
a lid coupleable to the top of the chamber such that the mixing aperture may thereby be sealed, the lid including:
a cover configured to cover the mixing aperture;
a shaft through the cover;
a plunger coupled to the shaft such that the plunger moves vertically in association with vertical movement of the shaft, the plunger shaped to conform to a horizontal cross-sectional shape of the side wall of the chamber; and
an actuator coupled to the shaft and the cover and configured to cause the shaft to move vertically when the actuator is actuated.

2. The grout applicator of claim 1, further comprising a flexible hose coupleable to the extrusion aperture and configured to fluidly couple to the chamber when coupled thereto and a nozzle coupled to the flexible hose and configured to direct fluid flow therefrom.

3. The grout applicator of claim 2, wherein the flexible hose comprises a substantially transparent hose.

4. The grout applicator of claim 3, further comprising a stop coupleable to the extrusion aperture and configured to form a fluid tight seal when coupled thereto, thereby preventing escape of fluid from the chamber.

5. A grout applicator, consisting essentially of:
a chamber of a material substantially impermeable to fluids, including:
a top, a bottom, and a side wall;
a mixing aperture through the top; and
an extrusion aperture through the side wall and closer to the bottom than the top; and
a lid coupleable to the top of the chamber such that the mixing aperture may thereby be sealed, the lid including:
a cover configured to cover the mixing aperture;
a shaft through the cover;
a plunger coupled to the shaft such that the plunger moves vertically in association with vertical movement of the shaft, the plunger shaped to conform to a horizontal cross-sectional shape of the side wall of the chamber; and
an actuator coupled to the shaft and the cover and configured to cause the shaft to move vertically when the actuator is actuated.

6. The grout applicator of claim 5, wherein the extrusion aperture includes a click-fit connector.

7. A grout applicator, consisting essentially of:
a chamber of a material substantially impermeable to fluids, including:
a top, a bottom, and a side wall;
a mixing aperture through the top; and
an extrusion aperture through the side wall and closer to the bottom than the top;
and
a lid coupleable to the top of the chamber such that the mixing aperture may thereby be sealed, the lid including:
a cover configured to cover the mixing aperture;
a shaft through the cover;
a plunger coupled to the shaft such that the plunger moves vertically in association with vertical movement of the shaft, the plunger shaped to conform to a horizontal cross-sectional shape of the side wall of the chamber; and
an actuator coupled to the shaft and the cover and configured to cause the shaft to move vertically when the actuator is actuated;
a flexible and substantially transparent hose coupleable to the extrusion aperture and configured to fluidly couple to the chamber when coupled thereto and a nozzle coupled to the flexible hose and configured to direct fluid flow therefrom; and
a stop coupleable to the extrusion aperture and configured to form a fluid tight seal when coupled thereto, thereby preventing escape of fluid from the chamber.

8. The grout applicator of claim 7, wherein the stop include a click-fit connector.
